(19) United States
(12) Patent Application Publication
(10) Pub. No.: US 2018/0189835 A1
(43) Pub. Date: Jul. 5, 2018

(54) GEOFENCE SYSTEM

(71) Applicant: INTERNATIONAL BUSINESS MACHINES CORPORATION, ARMONK, NY (US)

(72) Inventors: Lisa Seacat DeLuca, Baltimore, MD (US); Nicholas R. Sandonato, Raleigh, NC (US)

(21) Appl. No.: 15/399,048

(22) Filed: Jan. 5, 2017

(51) Int. Cl. G06Q 30/02

(52) U.S. Cl. CPC G06Q 30/0261; G06Q 30/0264; G06Q 30/0246

(57) ABSTRACT

Systems and methods for modifying campaign dependent geofences by creating marketing campaigns and linking the marketing campaign to a specific geofence. Each campaign-linked geofence may be capable of delivering the campaign messages to geofence participants during the duration of a marketing campaign and the geofence system may subsequently deactivate the geofence automatically after the marketing campaign has concluded. The systems and methods may map a geofence with a defined boundary to specified location on the map coinciding with the marketing campaign. As the tracked computer devices impinges on the borders of the market campaign's geofence, select messages may be received by the tracked computer devices, corresponding specifically to the events, promotions and advertisements of the campaign events during the time frame the events are active.

### TECHNICAL FIELD

The present disclosure relates generally to systems, methods and tools for creating, displaying and utilizing geofences.

### BACKGROUND

As portable devices, such as mobile communication systems, smart phones, tablet computers, laptops and navigation devices, become more advanced and powerful, these portable devices increasingly provide locational guidance to users in real time. More recently, portable devices have introduced a concept known as geo-fencing. A geofence is a virtual perimeter around a real-world location. Portable devices that implement geo-fencing functionalities may alert the user when the portable device has entered or exited an established geofence.

A geofence's perimeter may be virtually established around a point of interest such as an address, a business, landmark, home, etc. Programs that incorporate geo-fencing allow an administrator of a geofence to set up triggers so when a device enters (or exits) the boundaries of the geofence (defined by the administrator), a text message or email alert is sent. Many geo-fencing applications incorporate Google® Earth, allowing administrators to define boundaries on top of a satellite view of a specific geographical area. Other applications may define boundaries by longitude and latitude or through user-created and Web-based maps.

### SUMMARY

A first embodiment of the present disclosure provides a method for controlling a marketing campaign of a geofence comprising the steps of: creating, by a processor of a computer system, the marketing campaign comprising a campaign message; mapping, by the processor, the geofence having a virtual boundary defined by a location and size, the campaign message and an activation period of the geofence restricted to a conversion limit; tracking, by the processor, a number of conversions; and automatically deactivating, by the processor, the geofence as a function of reaching the number of conversions defined by the conversion limit of the geofence.

A second embodiment of the present disclosure provides a computer system, comprising: a central processing unit (CPU); a memory device coupled to the CPU; and a computer readable storage device coupled to the processor, wherein the storage device contains program code executable by the CPU via the memory device to implement a method for controlling a marketing campaign of a geofence comprising the steps of: creating, by a processor of a computer system, the marketing campaign comprising a campaign message; mapping, by the processor, the geofence having a virtual boundary defined by a location and size, the campaign message and an activation period of the geofence restricted to a conversion limit; tracking, by the processor, a number of conversions; and automatically deactivating, by the processor, the geofence as a function of reaching the number of conversions defined by the conversion limit of the geofence.

A third embodiment of the present disclosure provides a computer program product comprising: one or more computer readable hardware storage devices having computer readable program code stored therein, said program code containing instructions executable by the one or more central processing units (CPU) to implement a method for controlling a marketing campaign of a geofence comprising the steps of: creating, by a processor of a computer system, the marketing campaign comprising a campaign message; mapping, by the processor, the geofence having a virtual boundary defined by a location and size, the campaign message and an activation period of the geofence restricted to a conversion limit; tracking, by the processor, a number of conversions; and automatically deactivating, by the processor, the geofence as a function of reaching the number of conversions defined by the conversion limit of the geofence.

### BRIEF DESCRIPTION OF THE DRAWINGS

FIG. 1 depicts a schematic view of embodiment of a system for controlling a marketing campaign of a geofence consistent with the embodiments of the present disclosure.

FIG. 2 depicts a flow chart describing the system for controlling a marketing campaign of a geofence.

FIG. 3 illustrates an embodiment of geo-fencing module displaying a mapping interface.

FIG. 4 illustrates an embodiment of the mapping interface of FIG. 3 having an embodiment of an active geofence's virtual boundary depicted thereon.

FIG. 5a illustrates an embodiment of the mapping interface of FIG. 3 and a client device triggering the geofence having a conversion limitation.

FIG. 5b illustrates an embodiment of the geofence of FIG. 5a after a conversion limit has been reached.

FIG. 6a illustrates an embodiment of the mapping interface of FIG. 3 and a client device triggering an active geofence having a conversion limit and a time frame.

FIG. 6b illustrates the embodiment of the geofence of FIG. 6a after the conversion limit and/or time frame event has been met.

FIG. 7 illustrates an embodiment of the mapping interface of FIG. 3 and a client device transitioning between the virtual boundary of a geofence after a marketing campaign has concluded.

FIG. 8 illustrates an embodiment of an algorithm for controlling a marketing campaign of a geofence.

FIG. 9 depicts a block diagram of an embodiment of a generic computer system capable of implementing methods for controlling a marketing campaign of a geofence consistent with the embodiments described in this application.

### DETAILED DESCRIPTION

### Overview

Embodiments of the present disclosure recognize that currently available geofence systems displaying messages to users, potential clients and computer systems are neither self-creating nor self-terminating. When currently available geofences are created, the virtual barrier may persist perpetually and display a pre-programmed message. Often users or administrators of each geofence may forget to remove or deactivate the geofence after the displayed message is no longer relevant, an event has completed or a promotion has expired. The presence of persistent geofences may pose a problem due to the current geo-fencing device limitations. Mobile computing devices operating on the Android operating system may be limited to 100 active geofences. Likewise, mobile computing devices equipped with an iOS operating system may be limited to merely 20 active geofences. Irrelevant geofences remaining in the memory of the operating system may interfere with retrieving or mapping currently relevant geofences that may otherwise be unavailable or un-viewable.

Embodiments of the system for controlling a marketing campaign of a geofence improve upon currently available geofence systems by creating marketing campaigns, linking the marketing campaign to a specific geofence and establishing a conversion limit regulating the number of times a geofence may be triggered, the campaign message may be delivered or the a promotion may be used before the campaign expires. Each campaign-linked geofence may be capable of delivering campaign messages and promotions to geofence participants during the duration of a marketing campaign and the geofence system may subsequently deactivate the geofence automatically once a conversion limit is reached or a pre-set duration of the marketing campaign has concluded, whichever may occur first.

Embodiments of the computer systems managing the campaigns may define the date a marketing campaign begins, a date in which the marketing campaign ends, a type of conversion that may occur as a result of user's interaction with the geofence or taking advantage of the campaign promotions and a limit to the number of conversions that may occur for the particular geofence. The geofence linked to the marketing campaign may be generated and actively display marketing campaign messages during the defined marketing campaign duration, until the end date of the campaign or the conversion limit has been reached. Embodiments of the computer systems managing the campaign may transmit campaign messages to client devices triggering the geofence while the campaign is currently active and may continue to interact with triggering client devices until the conversion limit is reached.

In some embodiments, computer systems managing the geofence may map the geofence within a defined boundary to specified location on a map. The computer systems managing the geofence may track one or more computer devices entering, exiting and dwelling within the geofence (triggering events) linked to the marketing campaign. The computer systems may also track a conversion of the campaign and the campaign's promotions to determine whether or not a particular number of campaign conversions have been reached. For instance, the geofence being tracked may control the number of times a geofence may be triggered, the number of times a campaign message may be delivered to a client device, the number of times a campaign promotion may be used or the number of times a product associated with a campaign promotion may be purchased at the prices advertised by the campaign. messages.

Embodiments of the campaign management system may track the client devices using Global Positioning Satellites (GPS), Wi-Fi, Bluetooth, cell tower triangulation or other location techniques. As the tracked client devices impinge on the borders of the market campaign's geofence, select messages campaign may be received by the client devices being tracked, corresponding specifically to the special events, promotions and advertisements of the marketing campaign.

Embodiments of the geofences may be served and loaded into the memory devices of the client devices for a specified time period of the marketing campaign or until the pre-determined limit on conversions (conversion limit) has been reached by the campaign. Subsequently, after the marketing campaign has concluded or the conversion limit has been reached, the client device may no longer receive campaign messages or visibly observe the presence of a particular geofence tied to the deactivated marketing campaign. The client device or other computer systems managing the geofence may deactivate, remove and/or delete the expired geofences at the conclusion of the marketing campaigns or a specified time thereafter.

### System for Controlling a Marketing Campaign of a Geofence

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

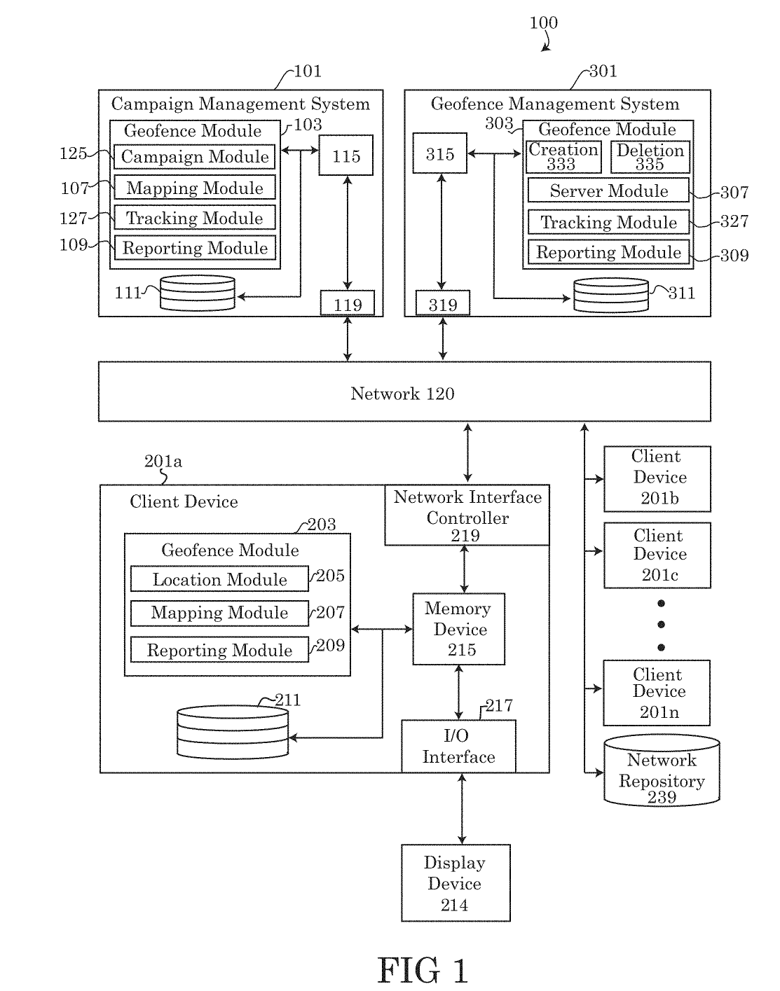

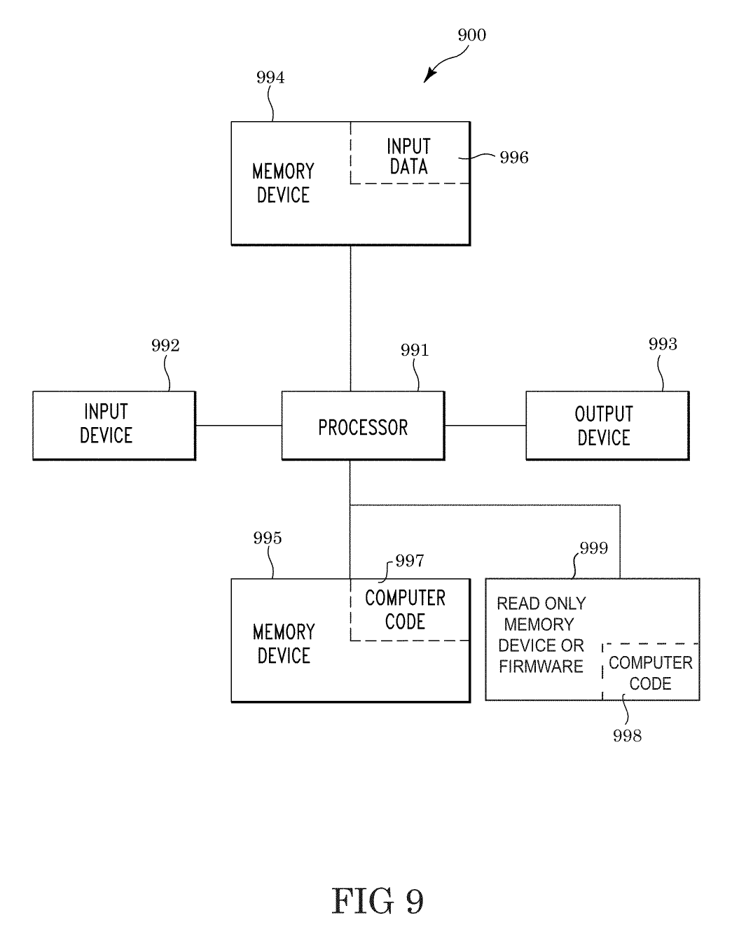

Referring to the drawings, FIG. 1 depicts a block diagram of an ephemeral geofence campaign system 100 (hereinafter “geofence system 100”) for controlling a marketing campaign of a geofence. Embodiments of the geofence system 100 may include a plurality of one or more computer systems, 101, 201, 301 including a campaign management system 101, a plurality of client devices 201a, 201b, 201c . . . 201n (referred collectively as “client device 201”) and a geofence management system 301. The computer systems 101, 201, 301 may each be a specialized computer system, having specialized configurations of hardware, software or a combination thereof as depicted in FIGS. 1-7 of the present disclosure and in the embodiments described herein. Embodiments of the computer systems 101, 201, 301 may not only comprise the elements of the systems and devices depicted in FIG. 1-7, but may also incorporate one or more elements of a generic computer system 900 as shown in FIG. 9 and described in detail below. Elements of the generic computer system 900 of FIG. 9 may be integrated into the specialized computer systems 101, 201, 301 of FIGS. 1-7.

Each of the computer systems 101, 201, 301 may each be connected and placed in communication with one another over a computer network 120. Embodiments of the network 120 may be constructed using wired or wireless connections between each hardware component connected to the network 120. As shown in the exemplary embodiments, each of the computer systems 101, 201, 301 may connect to the network 120 and communicate over the network 120 using a network interface controller (NIC) 119, 219, 319 or other network communication hardware. Embodiments of the NICs 119, 219, 319 may implement specialized electronic circuitry allowing for communication using a specific physical layer and a data link layer standard such as Ethernet, Fiber channel, Wi-Fi or Token Ring. The NIC 119, 219, 319 may further allow for a full network protocol stack, enabling communication over network 120 to the group of computer systems or other computing hardware devices linked together through communication channels. The network 120 may facilitate communication and resource sharing among the computer systems 101, 201, 301 and additional hardware devices connected to the network 120, for example a network repository 239 or other network accessible data structures stored by the network 120. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

In some embodiments of the geofence system 100, the geofence system 100 may include a campaign management system 101. The campaign management system 101 may perform the functions, tasks and services of system 100 directed toward creating a marketing campaign, campaign messages and messaging events associated with the marketing campaign. The campaign management system 101 may also set the limitations of the marketing campaigns, including a duration of time a campaign may extend and a conversion limit on the number of times an offer or promotion made by the campaign events may be used, that once reached may terminate the campaign earlier than the duration. Embodiments of the campaign management system 101 may provide configuration information in the form of campaign data 206 and geofence configuration data 306 to the geofence management system 301 during the geofence setup as well as during the linking of geofence to the marketing campaign. The campaign management system 101 may further track the status of the marketing campaign and the success of the campaign messages being delivered to the client devices 201 encountering the marketing campaign's geofence and the conversion rate of the campaign messages to purchases or.

Embodiments of the campaign management system 101 may include a geofence module 103. The term “module” may refer to a hardware based module, software based module or a module may be a combination of hardware and software resources. A module (whether hardware, software, or a combination thereof) may be designed to implement or execute one or more particular functions, tasks or routines of the systems. Embodiments of hardware based modules may include self-contained components such as chipsets, specialized circuitry and one or more memory devices. A software-based module may be part of a program code or linked to program code containing specific programmed instructions loaded in the memory device 115, 215, 315 of the specialized computer systems 101, 201, 301 of the geofence system 100. Embodiments of the geofence module 103, whether hardware, software or a combination thereof, may perform the functions and tasks associated with the creating the marketing campaign, linking the campaign to a geofence, mapping the geofence onto a user interface viewable by a client device 201, tracking the interactions between the client devices 201 and the geofence as well as reporting the conversion rate of the campaign messages, offers and promotions being utilized by the client devices and users thereof until a set conversion limit is reached. Embodiments of the geofence module 103 of the campaign management system 101 may include sub-modules designated with performing the individual tasks, routines and services of the geofence module 103. Various embodiments of the geofence module 103 may comprise a campaign module 125, mapping module 107, tracking module 127 and a reporting module 109.

Embodiments of the campaign module 125 may perform the task of creating, organizing, storing and transmitting marketing campaign data 206, including the creation, storage and transmission of campaign messages integrated into the geofences. In some embodiments, the campaign module 125 may store the created campaign messages in a campaign management database 111. The campaign module 125 may query the campaign management database 111 in response to campaign participant activity, requests made by a geofence management system 301 or a client device 201 to receive campaign messages as a function of the client device 201 triggering a campaign event of a mapped geofence.

In some embodiments, the campaign module 125 may set one or more parameters of the marketing campaign being stored and managed by the campaign management system 101 and the campaign management database 111. During the creation of a marketing campaign, a user may provide campaign input data 206 into the campaign management system 101 to set the configuration of the marketing campaign. For example, the campaign input data 206 entered into the campaign management system 101 may direct the campaign module 125 to configure a campaign with a specified start date/time, end date/end time, a conversion limit and the type of events that qualify toward achieving the conversion limit of the marketing campaign. For example, the types of qualifying events counted toward reaching the conversion limit may include transmitting a campaign message to a client device 201, displaying a campaign message on a client device, using a promotion or coupon transmitted as a campaign message or the purchase of one or more items promoted by a campaign message. The conversion limit may set a parameter for the number of times a particular qualifying event may occur before the campaign is deactivated, even if the conversion limit is reached before a pre-set date or time for termination of the campaign.

The campaign input data 206 may further define parameters for the campaign module 125 to create a marketing campaign. The campaign input data 206 may include information such as the organizer of the campaign, for example the individuals or companies running a promotion, the locations or regions that may be included or excluded from the marketing campaign. Additionally, the campaign input data 206 may further direct the campaign module's 125 creation or selection of the specific campaign messages, promotions, advertisements or other intellectual property associated with the marketing campaign that may be delivered to participants of the campaign. Embodiments of the campaign module 125 may load the marketing campaign, the campaign's parameters and the campaign messages into memory device 115 or the campaign management database 111. The campaign module 125 may modify, transmit or retrieve the marketing campaign data 206 configured and stored by the campaign management system 101 at a later point in time or when requested to do so by a separate computing system such as the geofence management system 301 or client device 201.

In some embodiments of the campaign management system 101, the geofence module 103 may further include a mapping module 107. The mapping module 107 may perform the function of configuring the conversion rate limited geofences and communicating with the geofence management system 301 during the geofence creation process. During the configuration of each geofence, an administrator of the geofence may utilize the campaign management system 101 to set one or more parameters of the geofence, link the geofence to marketing campaign of the campaign module 125, set the conversion limit and the types of qualifying events that count toward reaching the maximum allotted events of the conversion limit.

For example, the mapping module 107 may receive geofence configuration data 306 from an administrator of the campaign management system 101 defining the properties and parameters of the geofence. The geofence configuration data 306 may include data defining the geofence's identifying name, location, and size or boundary limits (i.e. longitude, latitude and radius). In some embodiments, the geofence configuration data 306 entered into the mapping module 107 may include input data defining a start date/time, an end date/time (also referred to as the expiration date), a conversion limit describing a maximum number of times one or more types of events may occur before the geofence is terminated or deactivated and the types of events that may qualify as counting toward the maximum number defining the conversion limit.

In the exemplary embodiment of the geofence system 100, the mapping module 107 may retrieve creation dates, expiration times and conversion limits for the geofence from the campaign module 125. The mapping module 107 may execute a command to load the marketing campaign's parameters created by the campaign module 125 into the memory device 115 of the campaign management system 101 during the geofence configuration process. In alternative embodiments, mapping module 107 may import or apply the parameters of the marketing campaign stored by the campaign management database 111 into the mapping module 107. For example, the mapping module 107 may be programmed to retrieve and load a marketing campaign by a specified name previously designated by the campaign module 125 during the creation of the campaign by the campaign administrator.

Geofence configuration data 306 inputted into the mapping module 107 may further configure one or more acceptable geofence transitions (e.g. enter, exit, dwell). The performance of a geofence transition by a client device 201 may trigger the transmission of a campaign message to the client device 201 interacting with the geofence once the geofence has been established and activated. The mapping module 107 may configure a response provided by the geofence upon the occurrence of one or more of the programmed transitions. For example, in some embodiments, when a client device 201 breaches the virtual boundary of the geofence and enters the geofenced area, a campaign message may be transmitted to the client device 201, describing nearby events, activities, promotions, coupons and products. Similarly, the exit transition may be programmed to allow for the campaign management system 101 to deliver a different campaign message to a client device 201 exiting the geofence. For instance, the campaign message may thank the user for participating in the marketing campaign and/or inform a campaign participant about upcoming promotions to look out for in the geofence space that the participant had just exited. Likewise, in some embodiments, where the transition selected is a “dwell” action, the mapping module 107 may configure the geofence to transmit a campaign message to a client device 201 once the tracked device has maintained a location within the geofence for a pre-set or pre-programmed amount of time.

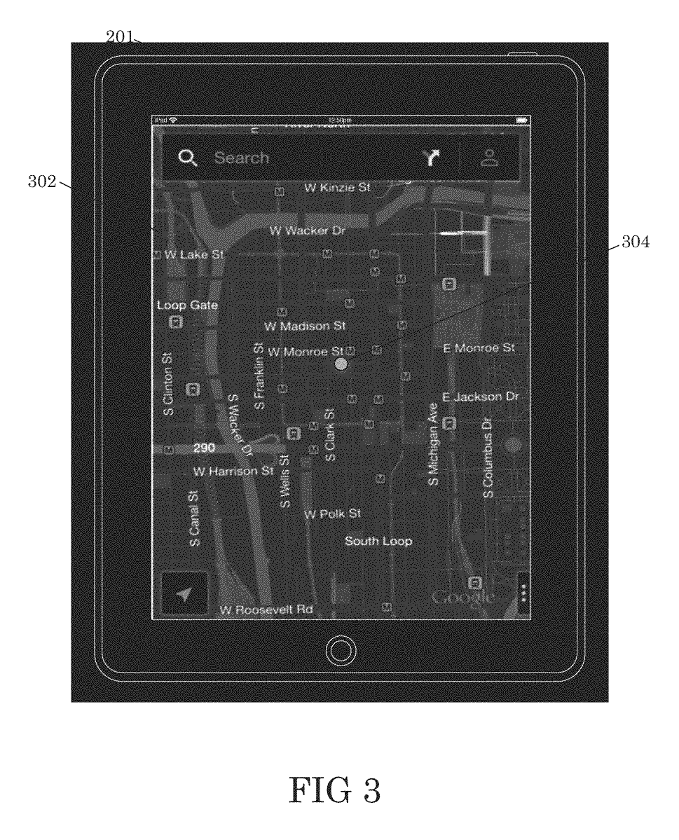

Embodiments of the mapping module 107 may transmit the configuration settings of the geofence from the campaign management system 101 to the geofence management system 301. The transmission may occur over network 120. For example, the mapping module 107 may transmit an API call from the campaign management system 101 to the geofence management system 301, requesting the geofence management system 301 create a geofence with the properties prescribed by the mapping module 107. Once the geofence has been created by the geofence management system, the mapping module 107 may receive the data of the created geofence and load the created geofence into memory device 115 of the campaign management system 101. The mapping module 107 may further plot each of the marketing campaign's geofences onto a mapping interface 302 depicting the location of each created geofence as shown in the examples of FIGS. 3-6 of the current application.

Embodiments of the geofence module 103 may further comprise a tracking module 127. The tracking module 127 may perform the tasks of collecting data and statistics about the geofence and the associated marketing campaign. The tracking module 127 may identify client devices 201 triggering the geofences, record the movements of the devices 201 by collecting location data from each of the client devices 201, receiving the collected location data from a geofence management system 301, calculate the conversion rate of the campaign messages, promotions and transitions into the geofence and further identify whether the conversion rate has reached the conversion limit. The tracking module 127 may be responsible for gauging the success or failure of a marketing campaign as a function of the client devices 201 triggering the geofence and participating with the campaign messages to creation a conversion of the campaign message into a use of a promotion, coupon or sale of product being marketed by the campaign.

Embodiments of the tracking module 127 may further collect and store identifying information about each of the users and the user's client devices 201. Identifying information data 210 may include a user's name, age, email address, home address, social media usernames and location information provided to the client device 201 by the location module 205. Embodiments of the tracking module 127 and/or tracking module 327 may collect statistical information that may draw conclusions of the success or failure of the marketing campaign and geofence. For example, the tracking module 127 may analyze the number of client devices 201 triggering a campaign message to be delivered, the viewing time of the campaign messages, whether or not the campaign messages were accepted or deleted, whether or not user's of the client device 201 converted the content of the campaign messages into a qualifying event such as a sale and the identifying demographics such as the age of the users receiving the campaign messages and the demographics of users converting messages into qualifying events.

Embodiments of the tracking module 127 may analyze the data collected from the client devices 201 and draw conclusions about the efficiency of the campaign, the target demographics and potential improvements to the campaign or geofence and the number of qualifying events contributing to the conversion limit. The tracking module 127 may compare the geofence and marketing campaign data with previous campaigns and geofences to identify the success of the campaign relative to previous campaigns that may have previously expired. The tracking module 127 may report the statistics and conclusions to the reporting module 109.

Embodiments of the reporting module 109 may generate one or more reports as a function of the statistics and conclusions collected and drawn by the tracking module 127. The reporting module 109 may present and display reports of the marketing campaign and campaign linked geofence to an administrator of the campaign management system 101. In some embodiments, the statistics, conclusions and data collected by the tracking module 107 may be archived in the campaign management database 111 or a network accessible repository 239 for further analysis or comparison with future marketing campaigns and geofences. In some embodiments, the reporting module 109 may report the presence of future geofences that may not have been activated yet, but are scheduled to be activated at the start of a corresponding upcoming marketing campaign and corresponding parameters including conversion limits and qualifying events of the conversion limit. Embodiments of the reporting module 109 may generate and display a report to the campaign management system 101 in some embodiments that provides a detailed listing of the active and pending marketing campaigns as well as the corresponding active and pending geofences scheduled to activate at the start of an upcoming marketing campaign start date.

As shown in FIG. 1, embodiments of the geofence system 100 may include a geofence management system 301, briefly described above and detailed further below. The geofence management system 301 may perform the tasks and functions of creating, deleting, mapping, tracking and generating geofences affiliated with a marketing campaign having a specified conversion limit and qualifying events contributing to the conversion limit. The geofence management system 301 may perform tasks of the geofence system 100 in a manner designated by the campaign management system 101 and further perform the task of serving the created geofences to a plurality of client devices 201 being tracked by the campaign management system 101. The geofence management system 301 may include a geofence module 303 to perform the designated tasks and functions a geofence management system 301.

Similar to the geofence module 103 of the campaign management system 101, the geofence module 303 of the geofence management system 301 may be a hardware module containing specialized chipsets and circuitry and/or or a software module loaded in the memory device 315 of the geofence management system 301. Embodiments of the geofence module 303 may include a creation module 333, deletion module 335, server module 307, tracking module 327 and a reporting module 309.

Embodiments of the creation module 333 may perform the task of generating the geofences corresponding to the marketing campaign data 206 and the geofence configuration data 306 inputted into the campaign mapping module 107. The creation module 333 may receive the configuration settings for the geofence from the mapping module 107 and/or the campaign module 125 of the campaign management system 101. The request to build the geofence to the specification of the campaign management system 101 may be received from the campaign management system in the form of an API call or other transactional request. The API call may be loaded in the memory device 315 of the geofence management system 301. The creation module 333 may analyze configuration settings and prescribed parameters of the geofence requested by the campaign management system 101 and confirm the settings are feasible or error free. If configuration settings for the geofence are infeasible or contain errors, the geofence creation module 333 may deny the request and further request a correction to the errors. Otherwise, if the configuration settings are feasible and error free, the creation module 333 may build the geofence according to the parameters, including the requested duration, expiration date, start time/date, end time/date, location, size, conversion limit, qualifying events contributing toward the conversion limit, the applicable transitions that will trigger the geofence and campaign messages that may be delivered to client devices meeting the transition settings for triggering the geofence. The creation module 333 may automatically activate each of the geofences according to the start date/time once the starting date/time has been met. In some embodiments, the activation of the geofence may not occur immediately upon creation. Instead, the activation may be delayed to coincide with the start date/time of the marketing campaign.

Embodiments of the creation module 333 may save and store the geofence and the geofence parameters in a geofence management database 311 or network accessible database, repository 239, data mart or other data structure. Saving and storing the geofences and the geofence configuration settings or parameters (including campaign messages, conversion limits and qualifying events contributing toward the conversion limit) may, in some embodiments, allow for the geofence management module 301 to repeatedly create the same geofences periodically, as instructed by the campaign management system 101. For example, a particular marketing campaign may occur every week, every month, every year, etc. The campaign management system 101 may in some embodiments, send an API call to execute the saved geofence by a particular geofence name or marketing campaign name. In response, the creation module 333 may query or lookup the geofence name in the geofence management database 311, load the previously stored configuration settings and parameters into memory device 315 and update the database entry to include a newly scheduled stating date, duration, expiration date and conversion limit.

Embodiments of the geofence module 303 may further comprise a server module 307. The server module 307 may serve the geofences (created by the creation module 333) to one or more client devices 201 accessing the geofence over network 120. Client devices 201 connecting to the geofence management system 301 may retrieve, store, download or actively stream the geofence data over network 120 from the server module 307. The server module 307 may periodically update the geofences and restrict or remove the ability to retrieve the geofences upon the geofence being deactivated due to expiration of time or reaching the conversion limit.

Embodiments of the tracking module 327 may collect location data 106, identifying user information, statistics of the geofence, the number times a geofence has been triggered by client devices 201, the number of campaign messages served to the client devices 201, the number/type of qualifying events contributing to the reaching the conversion limit and transmit the collected data from the geofence management system 301 to the tracking module 127 of the campaign management system 101. The tracking module 327 may identify conditions giving rise to the transmission of the associated campaign messages, including the identification of client devices meeting the transitions requirements (enter, exit, dwell) configured by the campaign management system 101. As a client device 201 receiving the geofence impinge on a virtual boundary of the geofence mapped by the mapping module 307, or dwells within the virtual boundaries of the geofence, the tracking module 327 may identify the triggering transition and transmit the associated campaign message resulting from transition's occurrence.

Embodiments of the mapping module 307 may transmit notifications to the client devices 201, including push notifications, emails, short messaging service (SMS) text messages or direct messaging services, containing campaign messages during active periods of a marketing campaign for a particular geofence. The push notifications transmitted from the geofence server module 307 to the device's mapping module 207 may be triggered as a function of the tracking module 327 identifying a client device 201 triggering an active geofence. In some embodiments, the server module 307 may be loaded with one or more secondary messages. A secondary message may be pushed to a client device 201 that has entered, exited or dwelled within a campaign's geofence prior to the campaign activation date or after the campaign has expired. Secondary message being pushed to the client device may inform the user of the client device 201 to come back during the dates of the campaign or to stay tuned for future campaigns that may occur within the particular geofence.

In some embodiments of the geofence management system 301, the geofence module 303 may include a reporting module 309. The reporting module 309 of the geofence management system 301 may perform the function of transmitting statistical information about the geofence and information collected by the geofence management system 301 during the activation of the geofence. The reporting module 309 may transmit the data to one or more computer systems 101, 201 over network 120. For example, the reporting module 309 may be responsible for transmitting data collected by the tracking module 327 to the campaign tracking module 127. The reporting module 309 may transmit statistics and data that may assist the campaign tracking module 127 with identifying the success or failure of the marketing campaign, the number of interactions users have with the geofence, the conversion rate of campaign messages that activated a qualifying event, the number of conversions in comparison with the conversion limit, demographic information about users interacting with the geofence, the attachment rate or rate at which campaign messages were positively or negatively received and/or acted upon by users of a client device 201 in a qualifying event.

The reporting module 309 may further identify the status of the geofence and whether or not the geofence is currently active, deactivated due to expiration of time, expiration as a function of reaching the conversion limit or deleted by the deletion module 335. Embodiments of geofences system 100 may select a deletion date for deleting the geofence that may occur at the end date of the marketing campaign or in alternative embodiments, the deletion date may occur automatically at a pre-set time after the marketing campaign has concluded. In some embodiments however, the deletion module 335 may receive requests to delete the geofence upon reaching the conversion limit, whereby a set number of qualifying events accounting for the conversion of the campaign messages into prescribed event have occurred a maximum number of times allotted for the geofence.

In some embodiments of the geofence system 100, the system 100 may include one or more client devices 201 connected to the campaign management system 101 and geofence management system 301 via computer network 120. A client device 201 may be any type of mobile computing device that may move or change locations. Some examples of a client devices 201 may include, but are not limited to mobile communication devices, smart phones, cell phones, laptops, tablet computers, smart watches and glasses, personal data assistants (PDA) and wireless or internet enabled media devices. The client devices 201 may be any type of touch point device capable of acting as a point of interaction with the geofence created by the geofence management system 301. The client devices 201 are not limited only to the number of devices depicted in the figures of the current application. Any number of client devices 201 may part of the geofence system 100 and connected to network 120. As shown in FIG. 1, the number of client devices may be open ended. The client devices 201 may include client devices 201a, 201b, 201c . . . 201n, wherein the ellipses represent an infinite number of client devices that may be present between 201c and the nth client device identified as the last device in the set of a plurality of client devices 201.

Embodiments of the client devices 201 may include a geofence module 203. The geofence module 203 of the client device 201 may provide access to and interaction with the conversion limited geofence created by the geofence management system 301 and the campaign management system 101. The geofence module 203 may be include specialized hardware physically connected within the client device 201 or the geofence module 203 may be software program or program instructions loaded in the memory device 215 of the client device 201. In alternative embodiments, the geofence module 203 providing access to the geofence and marketing campaign messages may be virtualized hardware that may be physically located via network 120 or a remotely accessible program executing program instructions for transmitting, receiving and displaying the data of the geofences. For example, the client device 201 may be accessing a virtualized geofence module through program or application services maintained by a cloud computing network.

Embodiments of the geofence module 203 may include a location module 205. The location module 203 may be comprised of hardware and/or software capable of utilizing a positioning system to pinpoint the current location of the client device 201 and/or previous positions of the client device 201 that may be stored in the memory device 215 and/or database 211. For example the location module 205 may utilize the positioning capabilities of the global positioning system (GPS), Wi-Fi, Bluetooth of Bluetooth low energy beacons, cell tower triangulation or a combination of positional systems. In some embodiments, the location module 205 may include a transmitter, receiver and/or transceiver for receiving location data 106 from a positioning system or broadcasting the location data 106 to the campaign management system 101 and/or the geofence management system 301. Embodiments of the location module 205 may save, store and update one or more sets of location data to a memory device onboard the location module, the memory device 215. and/or a local or remotely accessible database. The location module 205 may communicate the stored location data 106 to the geofence management system 301 and/or campaign management system 101 in order to allow each computer system 101, 301 to track the location of the client device 201, compare the location information with the established geofences of the marketing campaign, collect relevant data about the client device 201 or the device's user, triggering the geofence, push campaign messages to the client devices 201 meeting the transitioning conditions of the geofence and track the number of qualifying events contributing to the conversion limit of the conversion rate limited geofence.

The client device 201 may further comprise a mapping module 207. The mapping module 207 may perform the function of pinpointing the current location of the client device 201, monitor the position of the client device 201 in real time as the client device changes location and display the location of the client device 201 in relation to the position of each campaign geofence. Embodiments of the mapping module 207 may receive the data of the geofence from the geofence module 303 of the geofence management system 301. In particular, the mapping module 207 may download or retrieve geofence data from the geofence server module 307. The device's mapping module 207 may plot each of the geofences as a function of the geofence data onto a mapping interface 302 which may be displayed by a display device 214 of the client device 201. As shown by the Example in FIG. 3, the mapping module 207 may display the device location 304 onto a map interface 302 in real time, as a function of the location data 106 collected by the location module 205. The map interface 302 may depict the location surrounding the client device's current device location 304. As the client device 201 updates the location information of the location module 205, the device location 304 may be mapped onto the mapping interface 302 accordingly.

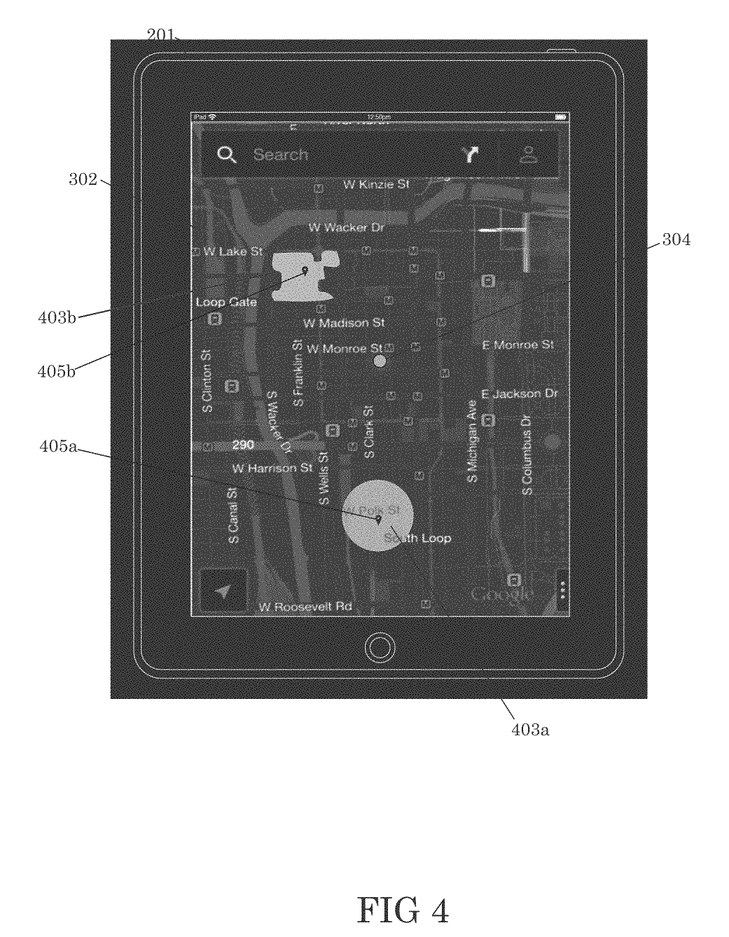

As shown in FIG. 4, the mapping module 207 may plot geofence events 405a, 405b and a surrounding geofence boundary 403a, 403b onto the mapping interface 302. The locations of each geofence event 405a, 405b and the size of the geofence boundaries 403a, 403b may be defined by the configuration settings prescribed by the mapping module 107 of the campaign management system 101 and subsequently created by the geofence management system 301 according to the prescribed settings. Each geofence event 405a, 405b may be tied to a region, store, public location, address, live event occurring in real time, or any other type of event. The timing of the geofence event 405a, 405b and the associated marketing campaign may be predetermined and/or timed to a specific start date/times. In some embodiments, the geofence events 405a, 405b may also have a pre-determined end date/times of a particular events real time length, however special promotions and geofences designed for the event may have a conversion limit that may cause the event to end once a specified number of qualifying events have occurred, rather than the scheduled end time.

For example, geofence events 405a, 405b may be a live event occurring in real time wherein the start date/time or end date/time mirror length or duration of the geofence. However, client devices triggering the events may perform qualifying actions to receive special promotions, discounts and products. However, the qualifying actions may be limited to particular number of qualifying actions, such as triggering the geofence boundary 403a, 403b, presenting a coupon while making a qualifying purchase or purchasing products advertised by the geofence. Alternatively, in some embodiments, the geofence event 405a, 405b may be linked to a particular store and may only be active during the store's real world hours. The geofence may deactivate while the store is closed and reactivate during the store's business hours. However, in some instances the store may run promotions and specials during the open hours that may be acted upon by a conversion limited number of users receiving notifications on the client device 201. The mapping module 207 may download, retrieve or stream the geofence data over network 120 and save the geofence data into memory device 215. The mapping module 207 may periodically download updates to the geofence data which may be provided by either the geofence management system 301 or the campaign management system 101.

Embodiments of the mapping module 207 may further download and retrieve campaign messages 510, 610 from the campaign management system and/or the geofence management system 301 as a function of the location information in comparison with the geofence boundary 403a, 403b. As shown in FIGS. 4-7, the boundaries 403a, 403b of each geofence can be any shape and size. For example, the boundary may be circular, square, rectangular, triangular, hexangular, etc. and even irregular shaped as depicted by geofence boundary 403b. Different campaign messages may be displayed as a function of the client device's 201 position, relative to the geofence boundary 403a, 403b and the geofence event 405a, 405b.

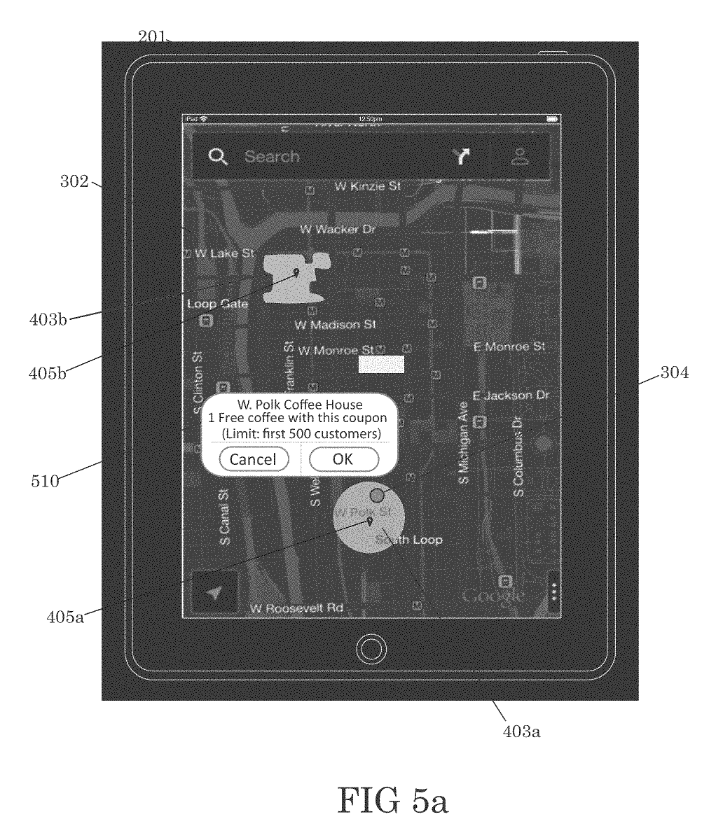

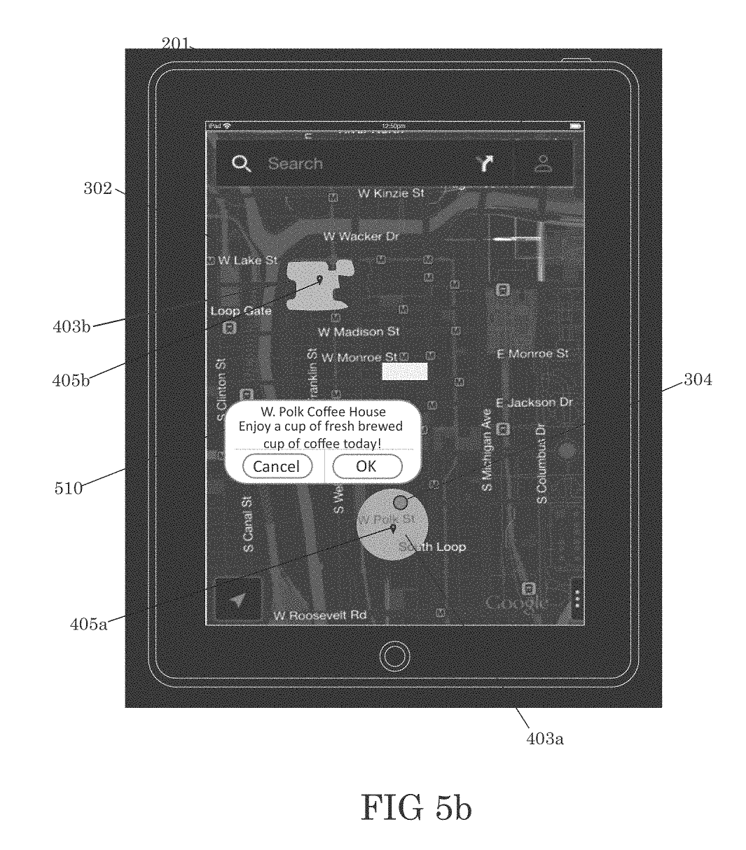

As depicted by the embodiment of FIG. 5a, the device location 304 of the client device 201 has changed location. As shown, the device location 304 has repositioned as a function of the location information, to a new position inside the geofence boundary 403a. In response to the penetration of the device location 304 into the geofence boundary 403a, the geofence management system 301 may transmit a campaign message 510 corresponding to the geofence event 405a, while the geofence event 405a is still operating under an active marketing campaign. As shown in FIG. 5a, a special promotion may be provided as part of the campaign message 510. The campaign message 510 may include a limited offer restricted by a conversion limit. In this particular example, the conversion limit is shown to be restricted to the first 500 customers to use the coupon (qualifying event) provided by the campaign message 510. The tracking module 327 may track the number of coupon uses. Accordingly, once the number of coupons provided as part of the campaign message are used, the campaign may deactivate and/or replace the campaign with a new campaign having a different campaign message 510.

As shown in FIG. 5b, once the number of qualifying events contributing to the conversion limit has reached the maximum amount of the conversion limit, the conversion limited campaigns may be deactivated and/or replaced with a different campaign. For instance, in FIG. 5b, the previous conversion limited campaign has reached the allotted 500 coupon uses and thus was deactivated. A new geofence replaced the conversion limited one as shown in FIG. 5b having a different campaign message. The newly substituted campaign may have a non-conversion limited campaign message being transmitted to client devices 201 in some embodiments, while in other embodiments, a new or different conversion limited geofence campaign may be created.

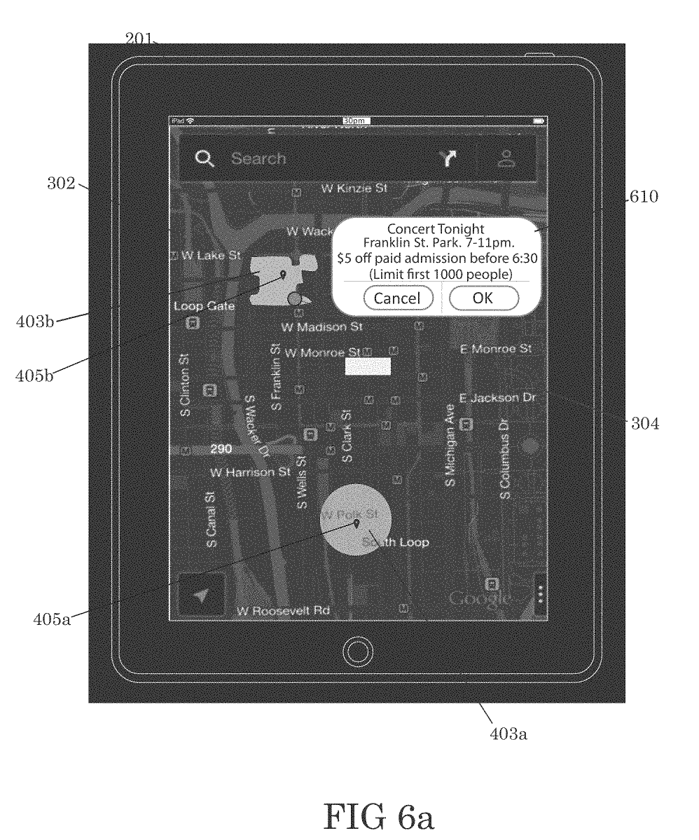

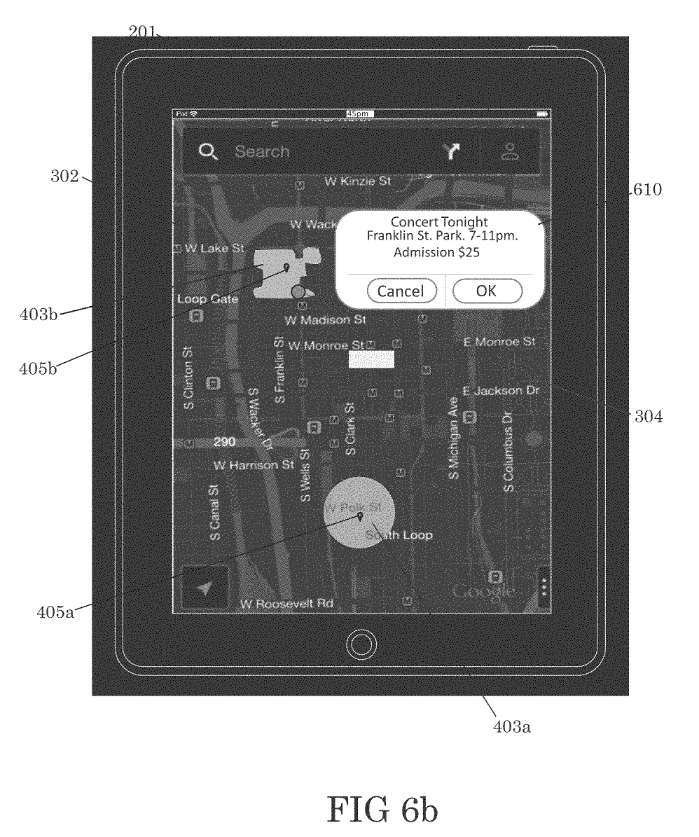

FIG. 6a depicts an embodiment of a client device 201 having a device location 304 positioned within the geofence boundary 403b of the geofence event 405b. As it can be observed, the marketing campaigns for geofence events 405a and 405b may differ from one another, thus, the campaign messages 510, 610 delivered when the geofence boundary 403a, 403b is penetrated differs accordingly. As shown in FIG. 6a, upon the change in position of the device location 304 to a location within the geofence boundary 403b of geofence event 405b, the geofence management system 301 transmits a campaign message 610 associated with the marketing campaign of geofence event 405b. In an embodiment of the geofence system 100, wherein the geofence events 405a, 405b are derived from different marketing campaigns, the campaign messages 510, 610 may differ as depicted by the figures. However, in some embodiments, the marketing campaigns may be the same campaign and thus penetrating the geofence boundaries 403a, 403b may result in the receipt of the same message. Embodiments of the reporting module 209 may receive the campaign messages provided by the geofence management system 301 and/or campaign management system 201. The reporting module 209 may display the appropriate campaign message on the display device 214 of the client device 201 triggering the geofences programmed transition.

As shown in FIG. 6a, a conversion limited campaign may have multiple conditions for terminating the campaign. Firstly, a campaign of a geofence may terminate the geofence by reaching the conversion limit of the offer or promotion once a total number of qualifying events meets the maximum of qualifying events allotted by the conversion limit. For instance, in FIG. 6a, the qualifying event for the conversion of the campaign message 610 is to purchase admission at a rate of $5 off. The conversion limit of 1000, limits the promotional offer to the first 1000 users of the client devices 201 to purchase admission to the event. As shown in FIG. 6b, once the requisite number of qualifying purchases have reached the conversion limit, the geofence and campaign message may be deactivated and/or replaced with a different geofence/campaign message 610.

Secondarily, if the conversion limit is not met, the conversion limited geofence campaign may still deactivate as a function of the time or duration of the geofence campaign. As shown in FIGS. 6a-6b, a second condition for receiving the promotional discount displayed, is to make the qualifying purchase before the designated time (i.e. 6:30 pm). Even if the number of conversions of the campaign messages to qualifying events has not been made by the designated time or duration, the geofence and/or the associated campaign may be terminated and/or replaced with another geofence as shown in FIG. 6b.

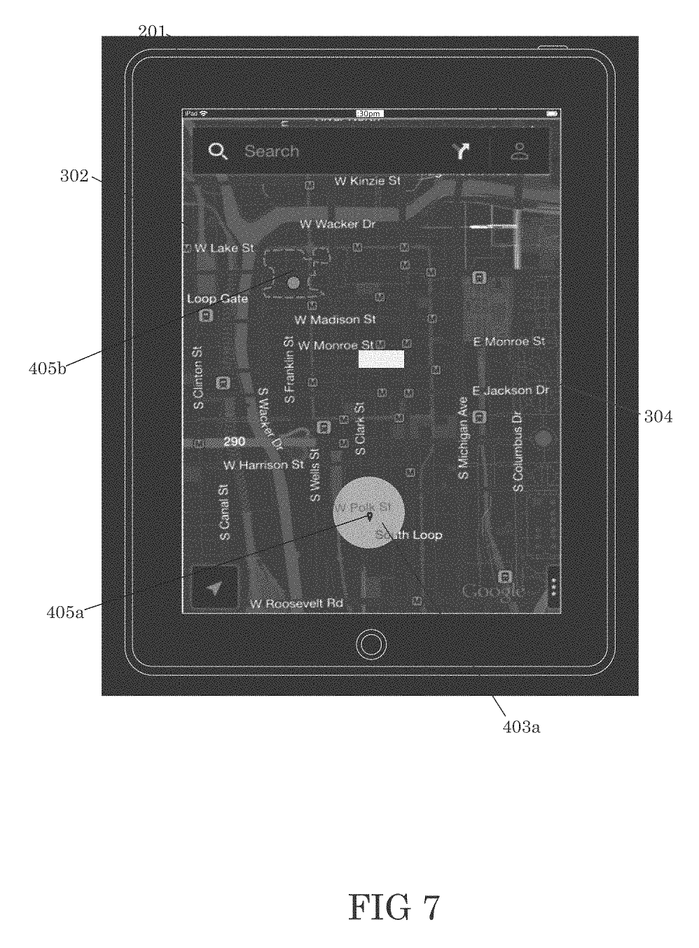

Embodiments of the mapping module 207 may continue to map and track the device location 304, even after the deactivation of one or more geofences. As shown in FIG. 7, one or more geofence events 405a, 405b may automatically deactivate as a function of the parameters prescribed during geofence creation by the campaign management system. For instance, once a marketing campaign associated with a geofence expires or the conversion limit has been reached, the geofence may automatically deactivate. The mapping module 207 of the mapping interface 302 may manually or automatically update as one or more campaign dependent geofences expire. As shown in the Example of FIG. 7, the geofence event 405b has expired. Even though the device location 304 is within the original geofence boundary 403b, the geofence no longer displays the affiliated campaign message 610 because the marketing campaign has ended.

In some embodiments, the campaign dependent geofence may be merely inactive once the marketing campaign has expired or deactivated due to meeting the requisite conversion limit. In alternative embodiments, the deletion module 335 of the geofence management system may schedule the conversion limited campaign geofence for deletion. In certain embodiments, the geofence may not be deleted, but rather scheduled for reactivation at a later time period prescribed by the campaign management system 101.

The campaign may be a rolling campaign that periodically activates and deactivates for a set period of time before reactivating automatically. In some embodiments, the tracking module 327 of the geofence management system may continue to collect and report informational device data 210 (or metadata) about the client devices 201 that may continue to enter, dwell or exit the boundary of the deactivated geofence. The collected informational device data 210 may be stored by the campaign management system 101 and used to determine the popularity of a geofence or potential geofence region. The campaign module 125 may determine one or more particular regions on the map to be optimal locations or demographics when it comes time to activate a new geofence. Likewise, the campaign module may also determine that a selected region for a geofence does not meet a particular standard. For example the previously selected location may not attract enough tracked devices 201 or attracts users of a demographic not in tune with the marketing campaign's demographics.

In some embodiments, the mapping module 207 may retrieve and display a secondary message to client devices 201 that enter a deactivated geofence. The secondary messages may provide information about previous campaigns, upcoming campaigns to be aware of in the current deactivated geofence or potential marketing opportunities for business to create a geofence within the deactivated geofence.

### Method for Controlling a Marketing Campaign of a Geofence

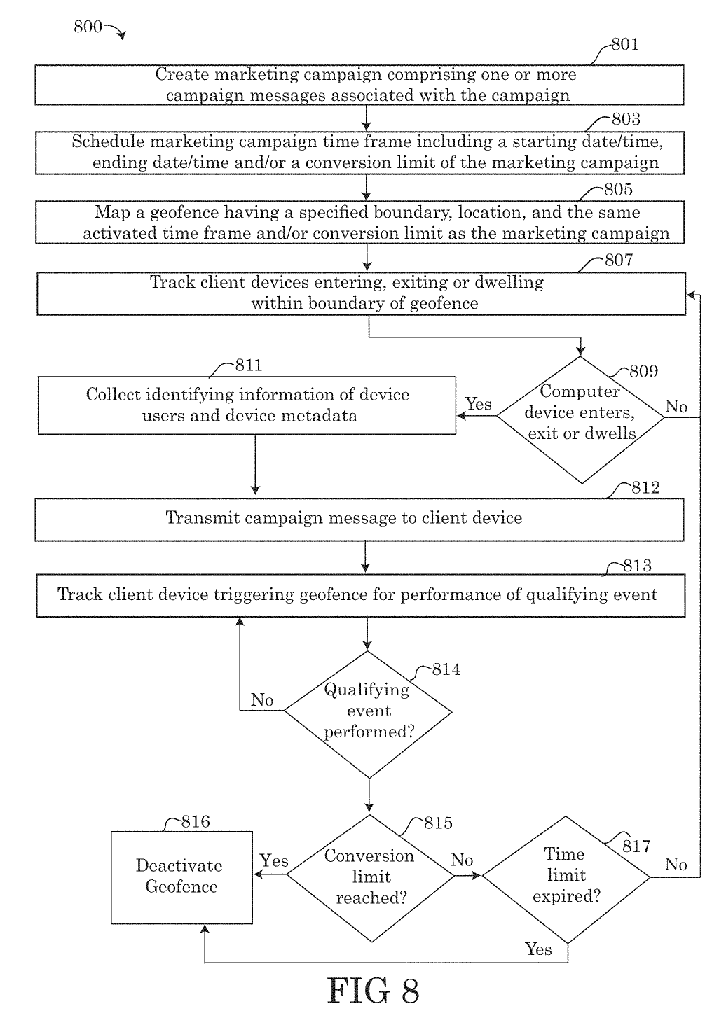

The drawing of FIG. 8 represents an embodiment of a method or algorithm that may be implemented for controlling a marketing campaign of a geofences in accordance with the geofence systems 100 described in FIGS. 1-7 using one or more computers as defined generically in FIG. 9 below, and more specifically by the embodiments of specialized computer systems 101, 201, 301 presented in FIGS. 1-7. A person skilled in the art should recognize that the steps of the algorithm described in FIG. 8 may be performed in a different order than presented by FIG. 8 and the algorithm may not require all of the steps described herein to be performed. Rather, some embodiments may create and terminate campaign dependent geofences using only one or more of the steps discussed below.

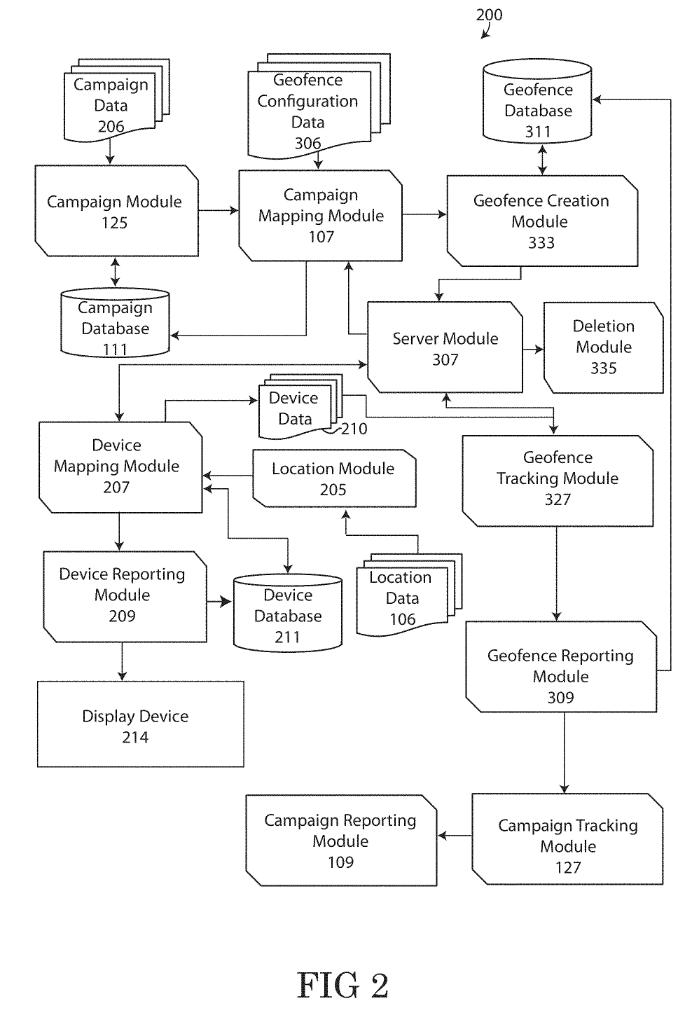

The embodiment of the method 800 for modifying campaign dependent geofences may begin at step 801. In step 801, the campaign management system 101 may create a marketing campaign comprising one or more campaign messages. The campaign messages may be created by the campaign module 125 and stored in the campaign management database 111 as depicted in the flow chart of FIG. 2. In some embodiments, the campaign module 125 may create a campaign name or other unique identifier to identify the particular campaign being created. The campaign name or identifier may be selected by a user or administrator of the campaign management system 101 and input via the campaign input data 206. In step 803 the campaign module 125 may further receive campaign input data 206 comprising one or more parameters of the marketing campaign. The campaign module 125 receiving the campaign input data 206, may further schedule the marketing campaign as a function of the campaign input data 206, including the duration of the campaign (i.e. the starting date, and time, ending date and time), the conversion limit, the types of qualifying events contributing toward reaching the conversion limit, including the number of campaign messages displayed to client devices 201, the number of times promotions displayed by the campaign messages are used during checkout of a good or service, the number of times a product is purchased that was advertised by the campaign message, and the number of times a geofence is triggered by a client device 201. In some embodiments, campaign input data 206 may further comprise settings for the campaign repeatability cycle (if any) and the regional locations affected by the campaign.

In step 805, the geofence system 100 may map each geofence having a specified boundary, location, activated time frame (start/end times) and conversion limit as the marketing campaign created in steps 801 and 803. The step of mapping the geofence in step 805 may be performed by the mapping module 107 of the campaign management system 101 inputting one or more parameters of the geofence being mapped. As shown by the embodiment of FIG. 2, the campaign mapping module 107, may receive the parameters as geofence configuration data 306 which may be inputted by a user or administrator of the campaign management system 101. Embodiments of the mapping module 107 may input each of the parameters of the geofence corresponding as prescribed by the geofence configuration data 306. The parameters entered by the campaign module may include an activation time (start date/time, end date/time), conversion limit, the types of qualifying events for reaching the conversion limit, cycling time and a region that matches the marketing campaign of steps 801 and 803. The mapping module 107 may select one or more locations for the geofence to be activated. The mapping module 107 may also continue by selecting the shape and size of the geofence in accordance with the campaign location and the geofence configuration data 306. The campaign mapping module may link the campaign messages from step 801 to the geofence configured by the mapping module 107 or retrieve and load the campaign messages from the campaign module 103.

Once the mapping module 107 has completed the configuration settings of the geofence as a function of the campaign and input data 206, 306, the mapping module may subsequently perform an API call to the geofence management system 301. The API call may be made request the geofence module 303 of the geofence management system 301 to generate a geofence having each of the properties configured by the mapping module 107. The request for generating the conversion limited geofence may be received by the geofence creation module 333. The geofence creation module 333 may analyze the configured settings received from the campaign mapping module 107. In some embodiments, the creation module 333 may check for anomalies, inconsistencies and errors between the geofence configuration data 306 and the campaign data 206 and if there are inconsistencies, anomalies or errors, the creation module may return an error to the campaign management system 101 and allow for correction. Likewise, the creation module 333 may generate a geofence having a time (frame) duration, expiration location, size, acceptable transitions and campaign messages prescribed by the configuration data received from the campaign mapping module 107. As shown in FIG. 2, the geofence data may be stored by the creation module 333 in the geofence database 311.

The mapping step 805 may continue by transmitting the geofence generated by the creation module 333 to the geofence management system's 301 server module 307. The server module 307 may transmit the created geofence and distribute the data depicting the geofence to a mapping interface of the campaign mapping module 107 and/or the client device's mapping module 207. Upon receiving the conversion limited geofences, the client device's mapping module 207 may plot each of the geofence's onto the mapping interface 302 displaying the device's location 304, each geofence event 405a, 405b and/or each geofence boundary 403a, 403b.

In step 807 of method 800, upon loading the geofence into the mapping module 207 of the client device 201 the system 100 may track each of client device 201 locations, identifying any client devices 201 that may trigger the programmed transitions of entering, exiting or dwelling within a geofence boundary 403a, 403b. The tracking step may be performed by geofence tracking module 327 and/or the device mapping module 207 receiving location data 106 of the client device 201 that may be collected by location module 205. Embodiments of the geofence system 100, may compare the received location data 106 with the location of each of the mapped geofence boundaries. In step 809, the geofence tracking module 327 making the comparison between the location data and the mapped geofence may determine whether or not the client computer device 201 has entered, exited or dwelled within a mapped geofence boundary of the marketing campaign. If, in step 809, it is determined that the tracked computer device 201 has not triggered a campaign message from the geofence, the method 800 may return to step 807 and continue to track the location of the client devices 201 that have loaded the geofence of the marketing campaign.

If, on the other hand, the geofence tracking module 327 identifies that the client computer device 201 has met one or more conditions for trigger a transition, by entering exiting or dwelling within the geofence as a function of the location data 106, in step 811, the tracking module 307 may collect device data 210 or metadata including identifying information about the client device 201 and the device's users. The device data 210 collected by the geofence tracking module 327 may be stored in the geofence database 311, network repository 239 and/or transmitted to the campaign tracking module 127 via the geofence's reporting module 309. The device data collected may provide valuable information to the campaign management system regarding the number of devices interacting with the geofence, the number of campaign messages accepted or ignored, the demographics of the device user's, the conversion rate as a ratio of campaign messages to resulting qualifying events counted toward the conversion limit and other statistical information that may gauge the success or failure of the marketing campaign. Identifying the success or failure of a particular marketing campaign may include the steps of counting the number of client computer devices 201 entering, exiting or dwelling within the boundaries of the geofence while the geofence is activated.

The geofence system 100 may identify the effectiveness of the marketing campaign as a function of the number of computer devices entering, exiting or dwelling within the boundaries of the geofence, the number of client computer devices 201 receiving a campaign message pushed to the client computer device 201, the number of tracked client devices that received the pushed campaign messages arrive at the geofence event location and/or take advantage of a promotion or advertisement that was pushed to the device 201 by converting the campaign message to a qualifying event counted toward the conversion limit.

As client devices 201 transition into and out of the geofence's boundaries 403a, 403b in step 809, the geofence management system may in step 812, transmit the campaign messages to the client device 201 as a function of the client device 201 triggering the geofence. The step of transmitting the campaign message may include the geofence management system 301 sending one or more campaign messages over network 120 to the NIC 219 of the client device 201. The received campaign messages may be stored in the memory device 215, mapped onto the mapping interface 302 by the mapping module and displayed by the display device 214 of the client device 201.

In step 813, the tracking module 327 may continue to track each of the client devices to determine whether or not the client device triggering the geofence converts the receipt of a campaign message transmitted in step 812 into the performance of a qualifying event described by the geofence that would count toward the conversion limit of the geofence. If, it is determined that a qualifying event is performed in step 814, the tracking module 327 may tabulate the conversion of the triggering of the geofence or receipt of the campaign message into a qualifying event. Subsequently, the tracking module 327 may further compare the total tabulated qualifying events counting towards the conversion limit with the maximum number of qualifying events established by the conversion limit in step 815. If the conversion limit is reached in step 815, the algorithm may move on to step 816, and deactivate and/or delete the geofence.

Alternatively, if in step 815, the system 100 makes the determination that the conversion limit has not been reached, the system may subsequently determine whether not a time limit for the geofence's activation period has expired (if a time limit was established) in step 817. Likewise, if there was not a time limit established and/or the time limit established for the geofence has not expired, the method 800 may proceed back to step 807 and continue to track additional client devices triggering the geofence boundaries. However, even if the conversion limit had not been reached in step 815, the expiration of the time limit in step 817 may cause the algorithm to move to step 816 and deactivate or delete the geofence via the deletion module 335 of the geofence management system 301

### Computer System

Referring to the drawings, FIG. 9 illustrates a block diagram of a computer system 900 that may be included in the systems of FIGS. 1-7 and for implementing methods for controlling a marketing campaign of a geofence as shown in the embodiment of FIG. 8 and in accordance with the embodiments described in the present disclosure. The computer system 900 may generally comprise a processor, otherwise referred to as a central processing unit (CPU) 991, an input device 992 coupled to the processor 991, an output device 993 coupled to the processor 991, and memory devices 994 and 995 each coupled to the processor 991. The input device 992, output device 993 and memory devices 994, 995 may each be coupled to the processor 991 via a bus. Processor 991 may perform computations and control the functions of computer 900, including executing instructions included in the computer code 997 for tools and programs for controlling a marketing campaign of a geofence, in the manner prescribed by the embodiments of the disclosure using the systems of FIGS. 1-7, wherein the instructions of the computer code 997 may be executed by processor 991 via memory device 995. The computer code 997 may include software or program instructions that may implement one or more algorithms for implementing the methods for controlling a marketing campaign of a geofence, as described in detail above. The processor 991 executes the computer code 997. Processor 991 may include a single processing unit, or may be distributed across one or more processing units in one or more locations (e.g., on a client and server).

The memory device 994 may include input data 996. The input data 996 includes any inputs required by the computer code 997, 998. The output device 993 displays output from the computer code 997, 998. Either or both memory devices 994 and 995 may be used as a computer usable storage medium (or program storage device) having a computer readable program embodied therein and/or having other data stored therein, wherein the computer readable program comprises the computer code 997, 998. Generally, a computer program product (or, alternatively, an article of manufacture) of the computer system 900 may comprise said computer usable storage medium (or said program storage device).

Memory devices 994, 995 include any known computer readable storage medium, including those described in detail below. In one embodiment, cache memory elements of memory devices 994, 995 may provide temporary storage of at least some program code (e.g., computer code 997, 998) in order to reduce the number of times code must be retrieved from bulk storage while instructions of the computer code 997, 998 are executed. Moreover, similar to processor 991, memory devices 994, 995 may reside at a single physical location, including one or more types of data storage, or be distributed across a plurality of physical systems in various forms. Further, memory devices 994, 995 can include data distributed across, for example, a local area network (LAN) or a wide area network (WAN). Further, memory devices 994, 995 may include an operating system (not shown) and may include other systems not shown in the figures.

In some embodiments, rather than being stored and accessed from a hard drive, optical disc or other writeable, rewriteable, or removable hardware memory device 994, 995, stored computer program code 998 (e.g., including algorithm) may be stored on a static, nonremovable, read-only storage medium such as a Read-Only Memory (ROM) device 999, or may be accessed by processor 991 directly from such a static, nonremovable, read-only medium 999. Similarly, in some embodiments, stored computer program code 997 may be stored as computer-readable firmware 999, or may be accessed by processor 991 directly from such firmware 999, rather than from a more dynamic or removable hardware data-storage device 995, such as a hard drive or optical disc.

In some embodiments, the computer system 900 may further be coupled to an Input/output (I/O) interface and a computer data storage unit (for example a data store, data mart or repository). An I/O interface may include any system for exchanging information to or from an input device 992 or output device 993. The input device 992 may be, inter alia, a keyboard, a mouse, sensors, biometric input device, camera, timer, etc. The output device 993 may be, inter alia, a printer, a plotter, a display device (such as a computer screen or monitor), a magnetic tape, a removable hard disk, a floppy disk, etc. The memory devices 994 and 995 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 900, and may include any type of transmission link, including electrical, optical, wireless, etc.

An I/O interface may allow computer system 900 to store information (e.g., data or program instructions such as program code 997, 998) on and retrieve the information from a computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that controls a marketing campaign of a geofence, to deploy or integrate computing infrastructure with respect to accessing content of a shared account. Thus, an embodiment of the present invention discloses a process for supporting computer infrastructure, where the process includes providing at least one support service for at least one of integrating, hosting, maintaining and deploying computer-readable code (e.g., program code 997, 998) in a computer system (e.g., computer 900) including one or more processor(s) 991, wherein the processor(s) carry out instructions contained in the computer code 997 causing the computer system to control a marketing campaign of a geofence. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of accessing content of a shared account. Thus the present invention discloses a process for supporting, deploying and/or integrating computer infrastructure, integrating, hosting, maintaining, and deploying computer-readable code into the computer system 900, wherein the code in combination with the computer system 900 is capable of performing a method of controlling a marketing campaign of a geofence.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for controlling a marketing campaign of a geofence comprising the steps of:
creating, by a processor of a computer system, the marketing campaign comprising a campaign message;
mapping, by the processor, the geofence having a virtual boundary defined by a location and size, the campaign message and an activation period of the geofence restricted to a conversion limit;
tracking, by the processor, a number of conversions; and
automatically deactivating, by the processor, the geofence as a function of reaching the number of conversions defined by the conversion limit of the geofence.

2. The method of claim 1, further comprising the step of:
transmitting, by the processor, a campaign message to each of the client devices triggering the geofence.

3. The method of claim 1, wherein the number of conversions is calculated to be a number of times the campaign message is displayed to each user of a client device.

4. The method of claim 1, further comprising the steps of;
transmitting, by the processor, a campaign message to each of the client devices triggering the geofence, wherein the campaign message is a promotional discount; and
tabulating, by the processor, a number of transactions performed using the promotional discount, wherein each use of the promotional discount is counted toward reaching the conversion limit.

5. The method of claim 1, wherein the step of automatically deactivating the geofence occurs as a function of a predetermined expiration date so long as the number of conversions is not achieved prior to the predetermined expiration date.

6. The method of claim 1, wherein the step of automatically deactivating the geofence occurs as a function of a predetermined number of users receiving the campaign message within a specified time limit.

7. The method of claim 1, wherein the campaign message is directed toward a specific item and the method further comprises the steps of:
tracking, by the processor, the purchase of the specified item; and
tabulating, by the processor, the purchase of the specified item of the campaign message toward reaching the conversion limit of the geofence.

8. The method of claim 1, further comprising providing at least one support service for at least one of creating, integrating, hosting, maintaining, and deploying computer-readable program code in a computer system, where the computer-readable program code in combination with the computer system is configured to implement the steps of creating, scheduling and mapping.

9. A computer system, comprising:
a processor;
a memory device coupled to the processor; and
a computer readable storage device coupled to the processor, wherein the storage device contains program code executable by the processor via the memory device to implement a method for controlling a marketing campaign of a geofence comprising the steps of:
creating, by the processor, the marketing campaign comprising a campaign message;
mapping, by the processor, the geofence having a virtual boundary defined by a location and size, the campaign message and an activation period of the geofence restricted to a conversion limit;
tracking, by the processor, a number of conversions; and
automatically deactivating, by the processor, the geofence as a function of reaching the number of conversions defined by the conversion limit of the geofence.

10. The system of claim 9, further comprising the step of:
transmitting, by the processor, a campaign message to each of the client devices triggering the geofence.

11. The system of claim 9, wherein the number of conversions is calculated to be a number of times the campaign message is displayed to each user of a client device.

12. The system of claim 9, further comprising the step of;
transmitting, by the processor, a campaign message to each of the client devices triggering the geofence, wherein the campaign message is a promotional discount; and
tabulating, by the processor, a number of transactions performed using the promotional discount, wherein each use of the promotional discount is counted toward reaching the conversion limit.

13. The system of claim 9, wherein the step of automatically deactivating the geofence occurs as a function a predetermined expiration date so long as the number of conversions is not achieved prior to the predetermined expiration date.

14. The system of claim 9, further comprising the steps of:
wherein the campaign message is directed toward a specific item and the method further comprises the steps of:
tracking, by the processor, the purchase of the specified item; and
tabulating, by the processor, the purchase of the specified item of the campaign message toward reaching the conversion limit of the geofence.

15. A computer program product comprising:
one or more computer readable hardware storage devices having computer readable program code stored therein, said program code containing instructions executable by one or more processors to implement a method for controlling a marketing campaign of a geofence comprising the steps of:
creating, by a processor of a computer system, the marketing campaign comprising a campaign message;
mapping, by the processor, the geofence having a virtual boundary defined by a location and size, the campaign message and an activation period of the geofence restricted to a conversion limit;
tracking, by the processor, a number of conversions; and
automatically deactivating, by the processor, the geofence as a function of reaching the number of conversions as defined by the conversion limit of the geofence.

16. The computer program product of claim 15, further comprising the step of:
transmitting, by the processor, a campaign message to each of the client devices triggering the geofence.

17. The computer program product of claim 15, wherein the number of conversions is calculated to be a number of times the campaign message is displayed to each user of a client device.

18. The computer program product of claim 15, further comprising the steps of;
transmitting, by the processor, a campaign message to each of the client devices triggering the geofence, wherein the campaign message is a promotional discount; and
tabulating, by the processor, a number of transactions performed using the promotional discount, wherein each use of the promotional discount is counted toward reaching the conversion limit.

19. The computer program product of claim 15, wherein the step of automatically deactivating the geofence occurs as a function of a predetermined expiration date so long as the number of conversions is not achieved prior to the predetermined expiration date.

20. The computer program product of claim 15, wherein the campaign message is directed toward a specific item and the method further comprises the steps of:
tracking, by the processor, the purchase of the specified item; and
tabulating, by the processor, the purchase of the specified item of the campaign message toward reaching the conversion limit of the geofence.
